(19) United States
(12) Patent Application Publication
(10) Pub. No.: US 2014/0214734 A1
(43) Pub. Date: Jul. 31, 2014

(54) CLASSIFYING A SUBMISSION

(71) Applicant: HEWLETT-PACKARD DEVELOPMENT COMPANY, L.P., Houston, TX (US)

(72) Inventors: Mehmet Kivanc Ozonat, San Jose, CA (US); Claudio Bartolini, Palo Alto, CA (US)

(73) Assignee: HEWLETT-PACKARD DEVELOPMENT COMPANY, L.P., Houston, TX (US)

(21) Appl. No.: 13/755,612

(22) Filed: Jan. 31, 2013

(51) Int. Cl. G06N 99/00

(52) U.S. Cl. CPC G06N 99/005
USPC 706/12

(57) ABSTRACT

A technique includes receiving a submission classified by a plurality of human classifiers. Based at least in part on a classification model for the plurality of human classifiers and classification decisions made by the human classifiers, the submission is classified.

### BACKGROUND

For purposes of identifying outdated and/or ineffective rules and policies, a business enterprise may solicit suggestions from its employees. In this manner, employees may submit, for example, email suggestions to the human resources group of the enterprise, and employees of the human resources group may classify/sort the submissions so that employees of the appropriate department are notified. In this manner, a given suggestion may concern a particular enterprise service, travel, finance, software, and so forth.

### BRIEF DESCRIPTION OF THE DRAWINGS

FIG. 1 is a schematic diagram of a computer-based system according to an example implementation.

FIG. 2 is a flow diagram depicting a technique to use a computer-based system to aid in the classification of a submission according to an example implementation.

FIGS. 3 and 5 are flow diagrams depicting techniques to adapt models for human classifiers according to example implementations.

FIG. 4 is an illustration of a model of a human classification process according to an example implementation.

### DETAILED DESCRIPTION

Techniques and systems are disclosed herein for purposes of receiving a submission previously classified by one or multiple human classifiers and processing this submission in a computer-based system to further improve the classification of the submission.

As a more specific example, a given business enterprise may have a suggestion initiative in which suggestions by its employees are solicited for purposes of updating outdated and/or otherwise inappropriate rules and policies of the enterprise. These suggestions, called “submissions” herein, may be classified by one or multiple employees of the enterprise. In this regard, a given submission may first be classified by the employee (called the “submitter” herein) and then be further classified by an employee of the human resources department, and this classification may, for example, be forwarded to a business unit associated with the classification for further classification.

Although initiatives to solicit such submissions may generally boost employee morale, such initiatives have certain risks of being counterproductive, in that the initiative may produce voluminous amounts of suggestions, which may result in a considerable amount of work related to the classifications. In other words, a considerable number of employees may be involved in sorting through the submissions to make sure that a given submission ends up with the appropriate employee in position to take action on the submission. The initiative may be relatively unsuccessful if, due to the large volume, a significant number of the submissions are not processed or incorrectly classified.

As a more specific example, a given submission may be classified, or mapped, to one of a predefined set of classes. Such classes may correspond to departments and/or functions of the enterprises, such as, for example, travel, human resources, finance, enterprise services, software, payroll, real estate and legal, as just a few examples. The goal of the classification process, in general, is to efficiently and accurately redirect the submissions to the appropriate employees of the enterprise so that these employees may consider and possibly act on the submissions.

As noted above, a given submission may be classified by multiple people in multiple business units. For example, the employee (i.e., the “submitter”) who makes a particular submission may make an initial classification by selecting a classification from a predefined set of classes, such as a drop window selection of classes provided by the enterprise's submission software. Unfortunately, however, the classification by the employee submitter may be relatively inaccurate, and therefore, a human resources employee may further classify the submission a second time for purposes of ideally improving the classification. The classification by the human resource employee, in turn, may not always be relatively accurate either; and as such, a third classification of the submission may be performed by a person in another business unit, such as a person in the enterprise services, travel, finance, or software business units (as a few examples) for purposes of once again attempting to more accurately route the submission to the appropriate employee.

Systems and techniques are disclosed herein for purposes of using a computer-based approach to generate relatively accurate classification for a given submission based on a relatively few number of human classifications. As further disclosed herein, because humans performing the classifications may be confined by certain time constraints or experience levels, models are developed in accordance with the systems and techniques that are disclosed herein to model the classification behavior exhibited at the various classification levels and further improve the classification based on this modeling.

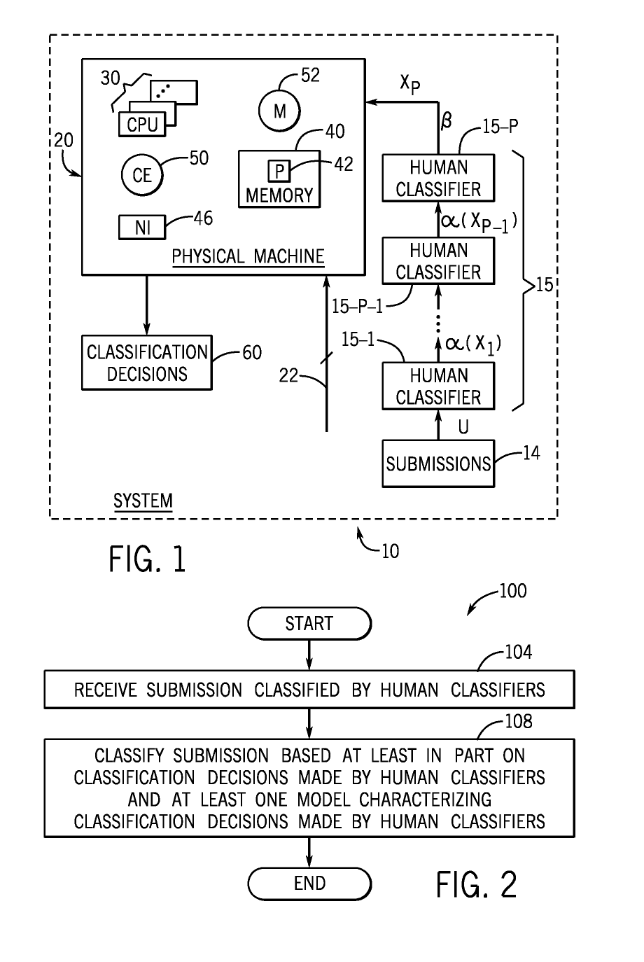

As a more specific example, a business enterprise may use a computer-based system 10, which is depicted in FIG. 1, for purposes of aiding the classification process for given exemplary submissions 14 to produce computer-aided classification decisions 60.

More specifically, the system 10 includes a physical machine 20, which contains a set of machine executable instructions to form a classification engine 50 for purposes of receiving a final classification from a serial chain of human classifiers 15 (a serial classification of human classifiers 15-1 . . . 15-P-1, 15-P, being depicted as examples in FIG. 1). In this context, the “serial chain” of human classifiers means that the classifications occur in a particular serial order, or sequence: human classifier 15-1 makes a classification decision that is processed by the human classifier 15-2, which makes a further classification decision that is then processed by the human classifier 15-3 to make a further classification decision, and so forth. This final classification provided by human classifier 15-P is represented by “β” in FIG. 1.

It is noted that the human classifier 15 of FIG. 1 is a vector representation of classifiers at a particular level of classification. For example, the human classifiers 15-1 may represent the employee submitters at the first level classification; the human classifier 15-2 may represent human resource employees at the second classification level; and so forth. Moreover, in this vector representation, “U” is a vector representing a set of submissions; and “β” is a vector representing a final level of human-based classifications.

The classification engine 50 processes the classification decisions β for purposes of further refining the classifications to produce the computer-aided classification decisions 60. For this purpose, the classification engine 50 represents the human classifiers 15 based on a model 52 that is constructed from classification training data 22. In this regard, the physical machine 20, in accordance with example implementations, executes a set of machine executable instructions that form a trainer 48 for purposes of developing the model 52 used by the classification engine 50, as further disclosed herein.

In general, the physical machine 20 is an actual machine that is made up of actual hardware and software. In this regard, the physical machine 20 includes such hardware as one or more central processing units (CPUs) 30 and a memory 40. The memory 40 may be a system memory (as an example) for the physical machine 20 in accordance with an example implementation.

In general, the memory 40 stores program data and program instruction data 42 (i.e., machine executable instructions), which are processed by the CPU(s) 30. In this regard, the CPU(s) 30 may execute program instructions that are stored in the memory 40 for purposes of forming various software components for the physical machine 20, such as the classification engine 50, the trainer 48, an operating system, device drivers, utilities, applications, and so forth. In general, the memory 40 may be formed from non-transitory storage devices, such as semiconductor storage devices, magnetic memory-based storage devices, optical-based storage devices or a combination of such devices, as examples.

Among its other hardware components, as examples, the physical machine 20 may include a network interface 46 that couples the physical machine 20 to network fabric, such as local area network (LAN)-based fabric, routers, switches, gateways, and so forth. Moreover, the physical machine 20 may include graphics accelerators, input devices, displays, and so forth, as can be appreciated by the skilled artisan. In general, the physical machine 20 may be a portable computer, an ultrabook computer, a tablet computer, a desktop computer, a client, a server, a smartphone, and so forth, depending on the particular implementation.

Although the physical machine 20 is depicted in FIG. 1 as being contained in a box or rack, the physical machine 20 may be a distributed machine that is disposed at several locations, in accordance with example implementations.

Referring to FIG. 2 in conjunction with FIG. 1, in accordance with example implementations, a technique 100 includes receiving a submission classified by human classifiers, pursuant to block 104. The submission is classified, based at least in part on classification decisions made by human classifiers and at least one model characterizing the classification decisions made by the human classifiers, pursuant to block 108.

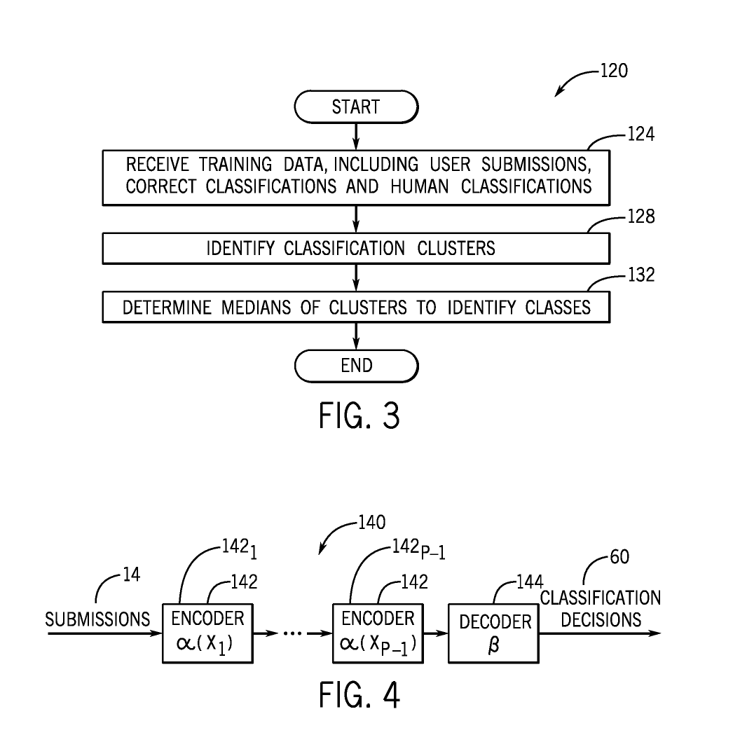

As a more specific example, in accordance with an exemplary technique, the trainer 48 may adapt the model 52, as illustrated in a technique 120 of FIG. 3. Referring to FIG. 3 in conjunction with FIG. 1, pursuant to the technique 120, training data is received (block 124), which includes user submissions, correct classifications and the corresponding human classifications. Based on this training data, the trainer 48 identifies classification clusters, pursuant to block 128. The trainer 48 then determines (block 132) medians of the clusters to identify classes, pursuant to block 132. In this regard, as disclosed herein, the trainer 48 may adapt the model 52 for purposes of identifying a subset of classes (70 classes as an example) from an original, larger set of classes (70,000 classes, for example) initially designated by the employee submitters. Thus, not only does the trainer 48 adapt the model 52 to account for characteristics of the human classifiers 15, the trainer 48 also, in accordance with example implementations, refines the end classes into which the submissions 14 are sorted.

Referring to FIG. 1, as a more specific example, in accordance with some implementations, the model 52 characterizes the human classifiers 15 as providing “encoded” classifications, as the human classifiers 15 may not have the adequate experience and/or time, for purposes of making an accurate classification of a given submission. As such, as depicted in FIG. 1, the human classifier 15-1 (i.e., the initial classifier 15 of the serial chain of classifiers) classifies user submissions 14 (represented by a vector called “U” in FIG. 1) to provide encoded classification decisions (represented by an encoded classification vector called “α(X₁)” in FIG. 1).

The encoded classification decisions α(X₁) that are generated by the human classifier 15-1, in turn, is provided to the human classifier 15-2. For example, the human classifier 15-1 may represent the employee submitters who make the initial classification, and the human classifier 15-2 may represent employees of the human resources department. Each human classifier 15, in turn, receives an encoded set of classification decisions and in response thereto provides a corresponding set of encoded classification decisions based on further classification/refinement by the human classifiers 15. As depicted in FIG. 1, the human classifier 15-P-1 provides an encoded set of classification decisions (called “α(X_{P-1}) in FIG. 1) to the last human classifier 15-P of the human classifier chain. The last human classifier 15-P is modeled as providing a decoded set of classification decisions, which form the β classification decisions. Thus, the serial chain of human classifiers 15 contain several serially-coupled links, where each link makes a classification decisions and provides these decisions to the next link of the human classification chain. The last link, in turn, provides decoded classification decisions for further analysis/classification by the classification engine 50.

As disclosed herein, the trainer 48 adapts the model 52 for purposes of determining the encoding functions a and further refining the ultimate set of classes (called “c” herein) into which the submissions 14 are ultimately sorted by the classification engine 50 to form the final classification decisions 60.

Referring to FIG. 4, in accordance with example implementations, the model 52 (see FIG. 1) may be represented by an encoding and decoding system 140. The system 140 includes a chain of serially coupled encoders 142 (encoders 142-1 . . . and 142-P-1, being depicted in FIG. 4 as examples), which correspond to the human classifiers 15-1 . . . 15-P-1 of FIG. 1, respectively. Each encoder 142 has an associated encoding function. For example, the encoder 142-1 has the α(X₁) encoding function. A decoder 144 of the system 140 corresponds to the human classifiers 15-P and receives the output from the last encoder 142-P-1 to provide a corresponding classification decision β. The trainer 48 determines the encoding functions α(X) as follows.

The classification decision focuses on the classification made by the decoder 144 with the help the decoder 144 receives from the encoders 142. Each encoding function α(X) is a function of “X,” which is a vector that represents the employees for the associated human classifier 15.

More specifically, due to time constraints imposed on the associated human classifiers and/or the experience levels of the associated human classifiers 15, the encoders 142 do not make a thorough classification decision. For the following example, it is assumed that the system 140 has two encoders 144 (corresponding to the encoding functions α₁(X₁) and α₂(X₂), respectively) although the system 140 may have a single encoder 142 or more than two encoders 142, in accordance with further implementations. The goal of the classification by the decoder 144 is to minimize the following cost function:

P(C(U)≠β(α₁(X₁)),α₂(X₂),X₃)), Eq. 1

where “P” represents a probability; “C(U)” represents the true class of the submission U; “X₁” represents the employees of human classifier 15-1; “X₂” represents the employees of human classifier 15-2; and “X₃” represents the employees of human classifier 15-3.

Minimizing Eq. 1 for given time constraints may be viewed as a vector quantization problem having two independent encoders and a common decoder with side information such that the encoding functions are α₁ and α₂; the decoding function is β; the side information is X₃; and the corresponding cost function may be described as follows:

P(C(U)≠β(α₁(X₁)),α₂(X₂),X₃))+λₙTₙ,n=1,2, Eq. 2

where “T₁” represents the expected time limits for the job of classification for the encoder 142-1; “T₂” represents the expected time limits for the classification for the encoder 142-2; “λ₁” represents the Lagrangian parameter for the encoder 142-1; and “λ₂” represents the Lagrangian parameter for the encoder 142-2.

In accordance with example implementations, the trainer 48 may function as a vector quantizer minimizing the cost function of Eq. 2 using the Lloyd algorithm by iteratively updating the encoding, decoding and time functions. For the following discussion, the indices for the encoders 142-1 and 142-2 are denoted by “i,” where 1≦i≦I and “j,” where 1≦j≦J, respectively. In these expressions, “I” and “J” are the number of indices for the respective encoders. Thus, the indices correspond to corresponding codewords. In the discussions below, the corresponding time functions for the encoders 142-1 and 142-2 are denoted by “t₁” and “t₂,” respectively.

In accordance with an example implementation, an iteration of the Lloyd algorithm to update the encoding, decoding and time functions may be performed as follows. First, for each vector X1, the encoding function α(X₁) for the encoder 142-1 may be updated by applying the following minimization:

α(x1)=ar gmin₁P(C(U)≠β(α₂(X₂),X₃|X₁=x₁)+λ₁t₁(i). Eq. 3

Next, the time function t₁ for encoder 142-2 is updated. The t₁ time function may be updated in many different ways, depending on the particular implementation. For example, in accordance with an example implementation, an assumption may be made that the successively transmitted (or received) indices are encoded (or decoded) independently. As such, the optimum expected rate is the entropy of the quantizer indices. Accordingly, the time function t₁ may be set equal to the logarithm of the inverse of the probability of the index i. In further implementations, another codding approach may be used, such as jointly encoding or decoding the successive indices using, for example, Slepian-Wolf coding. Thus, many variations are contemplated, which are within the scope of the appended claims.

Next, with the time function t₁ being updated, the trainer 48 updates the next encoding function α₂ (X₂). In this regard, in accordance with example implementations, the trainer 48 minimizes a cost function that is analogous to Eq. 3 to determine the index j for the decoding function D. Subsequently, the trainer 48 updates the associated time function t₂ for the encoding function α₂ (X₂). Thus, the result of the above-described process is to arrange the decoding results into clusters. The last step, described below, is applied by the trainer 48 for purposes of using the clusters to consolidate classes c. More specifically, in accordance with an example implementation, the trainer 48 minimizes the following cost function for each triplet (i, j, x₃), as follows:

(i,j,x3)=ar gmin_{c}P(C(U)≠c|α₁(X₁)=i,α₂(X₂)=j,X₃=x₃). Eq. 4

Due to this minimization, a reduced set of classes is formed.

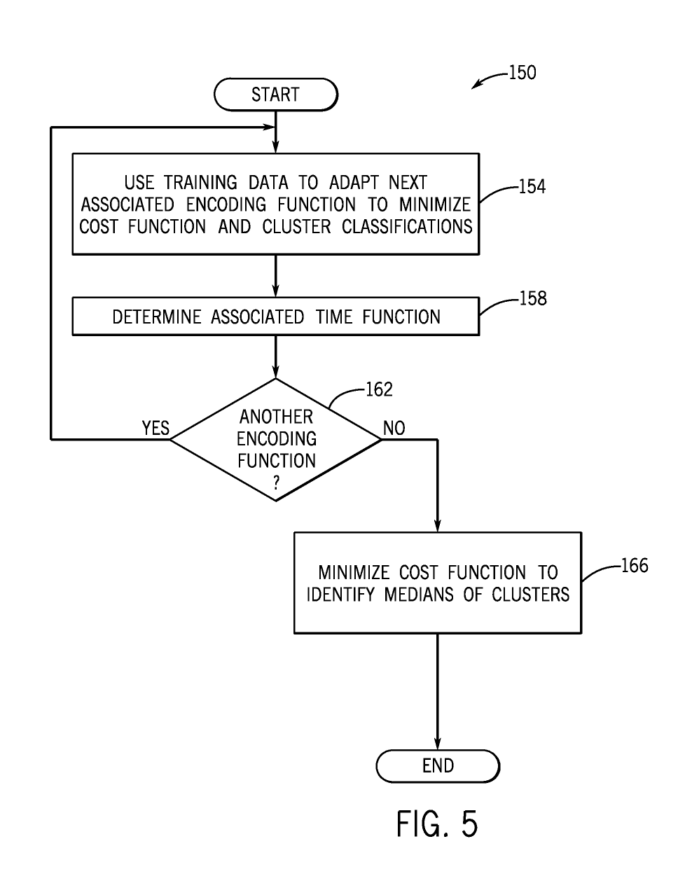

Thus, referring to FIG. 5, in accordance with example implementations, the trainer 48 may perform a technique 150 that is illustrated in FIG. 5. Referring to FIG. 5, the technique 150 includes using (block 154) training data to adapt the next encoding function to minimize a cost function and cluster classifications. An associated time function for the encoding function is also determined, pursuant to block 158. If a determination is made (decision block 162) that another encoding function is to be adapted, then control returns to block 154 to adapt (block 154) the next encoding function and determine its associated time function (block 158). Otherwise, the trainer 48 minimizes (block 166) a cost function to identify medians of clusters, pursuant to block 166 for purposes of consolidating classes.

While a limited number of examples have been disclosed herein, those skilled in the art, having the benefit of this disclosure, will appreciate numerous modifications and variations therefrom. It is intended that the appended claims cover all such modifications and variations.

What is claimed is:

1. A method comprising:
receiving a submission classified by a plurality of human classifiers;
based at least in part on a classification model for the plurality of human classifiers and classification decisions made by the human classifiers, classifying the submission.

2. The method of claim 1, wherein classifying the submission comprises applying at least one encoder modeled after a human classifier of the plurality of the human classifiers.

3. The method of claim 1, wherein classifying the submission comprises applying at least one decoder modeled after a human classifier of the plurality of the human classifiers.

4. The method of claim 1, wherein receiving the submission comprises receiving a submission classified by the plurality of human classifiers in a serial chain of classifications, wherein each human classifier of the plurality of classifiers comprises a link of the chain.

5. The method of claim 1, wherein receiving the submission comprises receiving a submission concerning a problem with an enterprise and classifying the submission comprises assigning the problem to a class of a predetermined set of classes.

6. A system comprising:
a classification engine comprising a processor to classify a submission based at least in part on classifications of the submission provided by a plurality of human classifiers and a classification model for the plurality of human classifiers; and
a trainer to adapt the classification model based at least in part on classification training data.

7. The system of claim 6, wherein:
the classification engine comprises at least one encoder modeled after a human classifier of the plurality of human classifiers, and
the trainer is adapted to regulate encoding applied by the at least one encoder based at least in part on the classification training data.

8. The system of claim 7, wherein the trainer is adapted to further base the regulation of the encoding applied by the at least one encoder on a minimization of a probability of the plurality of classifiers not providing a correct classification and a rate function of the at least one encoder.

9. The system of claim 6, wherein:
the classification engine comprises at least one additional encoder modeled after a human classifier of the plurality of human classifiers, and
the trainer is adapted to regulate encoding applied by the at least one additional encoder based at least in part on the classification training data.

10. The system of claim 6, wherein the trainer is adapted to adapt encoders to form clusters of classifications based at least in part on the classification training data.

11. The system of claim 10, wherein the trainer is further adapted to identify classes for the model based on a statistical analysis of the clusters.

12. The system of claim 6, wherein
the classification engine associates the human classifiers with a plurality of encoders and a decoder; and
the trainer is adapted to adapt the encoders and the decoder based at least in part on the classification training data.

13. The system of claim 6, wherein receiving the submission identifies a problem with an enterprise, and the classification engine is adapted to assigning the submission to a class of a predetermined set of classes based at least in part on the problem.

14. An article comprising a non-transitory storage medium to store instructions that when executed by a processor-based system cause the processor-based system to:
classify a submission based at least in part on classifications of the submission provided by a plurality of human classifiers and classification model for the plurality of human classifiers; and
adapt the classification model based at least in part on classification training data.

15. The article of claim 14, the storage medium storing instructions that when executed by the processor-based system cause the processor-based system to:
regulate encoding applied by the at least one encoder modeled after a human classifier of the plurality of human classifiers based at least in part on the classification training data.

16. The article of claim 15, the storage medium storing instructions that when executed by the processor-based system cause the processor-based system to:
further base the regulation of the encoding applied by the at least one encoder on a minimization of a probability of the plurality of classifiers not providing a correct classification and a rate function of the at least one encoder.

17. The article of claim 14, the storage medium storing instructions that when executed by the processor-based system cause the processor-based system to:
regulate encoding applied by at least one additional encoder based at least in part on the classification training data.

18. The article of claim 14, the storage medium storing instructions that when executed by the processor-based system cause the processor-based system to adapt encoders to form clusters of classifications based at least in part on the classification training data.

19. The article of claim 14, the storage medium storing instructions that when executed by the processor-based system cause the processor-based system to identify classes for the model based on a statistical analysis of the clusters.

20. The article of claim 14, wherein the model associates the human classifiers with a plurality of encoders and a decoder, the storage medium storing instructions that when executed by the processor-based system cause the processor-based system to adapt the encoders and the decoder based at least in part on the classification training data.
